(19) United States
(12) Patent Application Publication
(10) Pub. No.: US 2025/0106544 A1
(43) Pub. Date: Mar. 27, 2025

(54) Adaptive Interface in Active Noise Reduction (ANR) Headset

(71) Applicant: Bose Corporation, Framingham, MA (US)

(72) Inventor: Paul G. Yamkovoy, Acton, MA (US)

(21) Appl. No.: 18/371,144

(22) Filed: Sep. 21, 2023

(51) Int. Cl. H04R 1/10

(52) U.S. Cl. CPC H04R 1/1041; H04R 1/1008; H04R 1/1083

(57) ABSTRACT

Various aspects include active noise reduction (ANR) headsets and methods of controlling such headsets. In some implementations, a headset includes: at least one electro-acoustic transducer; and at least one control circuit coupled with the at least one electro-acoustic transducer, the at least one control circuit configured to detect an acoustic disturbance in environmental sound, wherein the acoustic disturbance is characterized by a noise level in the environmental sound deviating from a noise threshold, and disable an audio pass-through mode while the acoustic disturbance is detected.

### TECHNICAL FIELD

This disclosure generally relates to wearable audio devices, such as headsets. More particularly, the disclosure relates to active noise reduction (ANR) headsets and related methods of controlling such headsets.

### BACKGROUND

Relative to headsets (e.g., audio headsets) that provide only passive noise reduction (or, occlusion), headsets deploying active noise reduction (ANR) systems can significantly enhance user comfort and improve communications. However, interfaces for ANR systems and associated acoustic components can be susceptible to false triggering in high-noise environments.

### SUMMARY

All examples and features mentioned below can be combined in any technically possible way.

Various implementations of the disclosure include active noise reduction (ANR) headsets and methods of controlling such headsets.

In some particular aspects, a headset includes: at least one electro-acoustic transducer; and at least one control circuit coupled with the at least one electro-acoustic transducer and configured to detect an acoustic disturbance in environmental sound, wherein the acoustic disturbance is characterized by a noise level in the environmental sound deviating from a noise threshold, and disable an audio pass-through mode while the acoustic disturbance is detected.

In additional particular aspects, a method of controlling an active noise reduction (ANR) headset includes: detecting an acoustic disturbance in environmental sound, wherein the acoustic disturbance is characterized by a noise level in the environmental sound deviating from a noise threshold, and disabling an audio pass-through mode while the acoustic disturbance is detected.

Implementations may include one of the following features, or any combination thereof.

In some cases, the acoustic disturbance is detected based on a shape of an electrical pulse or waveform. In particular aspects, additional acoustic disturbances and/or contributors are compared with the noise threshold or otherwise contribute to the threshold, for example, head movement by a user of the headset deviating from a head movement threshold or jaw movement by a user of the headset deviating from a jaw movement threshold.

In particular aspects, audio pass-through mode enables pass-through (or audio output) approximating voice and other mid-frequency and/or high-frequency sound while canceling low-frequency sound such as aircraft noise. In further cases, the audio pass-through mode can allow for true, or near transparency, enabling pass-through of approximately all ambient sound. In still further cases, audio pass-through mode includes a frequency filter and/or another filter such as an equalization filter or a volume adjustment filter (e.g., volume boost for particular frequencies).

In certain aspects, the at least one control circuit is configured to sample environmental sound on a periodic basis or a continuous basis.

In particular cases, the at least one control circuit is further configured to, sample the environmental sound after detecting the acoustic disturbance in the environmental sound, enable the audio pass-through mode in response to the environmental sound satisfying a threshold, and maintain disablement of the audio pass-through mode in response to the environmental sound deviating from the threshold.

In some implementations, the acoustic disturbance is detected by environmental sound exceeding the noise threshold as defined by a nominal amount of noise.

In certain cases, the nominal amount of noise is equal to approximately 90 decibels (dB), approximately 95 dB, approximately 100 dB, approximately 105 dB, approximately 110 dB, approximately 115 dB, or approximately 120 dB.

In some aspects, the acoustic disturbance is detected by environmental sound exceeding the noise threshold as defined by a relative amount of noise in a period.

In certain implementations, the relative amount of noise is defined by an increase in noise of: a) approximately 20 decibels (dB), approximately 25 dB, approximately 30 dB, approximately 35 dB, or approximately 40 dB in the period, or b) approximately 10 percent, approximately 15 percent, approximately 20 percent, approximately 25 percent, or approximately 30 percent in the period.

In some aspects, a hysteresis factor is used in evaluating the environmental sound as compared with the noise threshold(s).

In particular cases, the at least one control circuit is further configured to filter voice signals from the environmental sound.

In certain implementations, the at least one control circuit is configured to detect the acoustic disturbance in a limited frequency range of the environmental sound. In some cases, the limited frequency range includes lower frequencies such as those occurring during flight and/or higher frequencies such as high-pitched alerts.

In some cases, disabling the audio pass-through mode is further based on a detected current load on the at least one control circuit in the headset. In particular examples, the current load on the at least one control circuit is impacted by noise in the ambient sound and/or a user action such as a user tapping on an ANR interface control and/or a user chewing or turning her head abruptly.

In certain aspects, the headset includes two earphones, and the at least one control circuit is configured to verify the acoustic disturbance based on an acoustic characteristic of the environmental sound as detected at both of the two earphones. In particular cases, the earphone includes an earcup or an earbud.

In some implementations, the headset further includes a first set of ANR microphones at a first one of the two earphones and a second set of ANR microphones at a second one of the two earphones, where the at least one control circuit is coupled with both the first set of ANR microphones and the second set of ANR microphones.

In particular cases, the at least one control circuit is further configured to periodically or continuously sample the environmental sound and define an average noise characteristic for the environmental sound over a period. Continuous sampling can be performed at defined intervals and/or dynamic intervals, or periodically at such intervals. Average noise characteristics can be measured, e.g., as sound pressure level (SPL).

In certain aspects, the at least one control circuit is further configured to update the average noise characteristic on a rolling basis. In some cases, the average noise characteristic includes a noise envelope, or a profile of a noise amplitude that changes over time and is updated.

In some cases, the threshold is specific to at least one of, a user of the headset (e.g., user profile(s)), a population of users, a type of use environment for the headset (e.g., aviation, automotive, industrial), or a type of vehicle in which the headset is operated (e.g., an aircraft with a noise spectrum such as a range of high-frequency to low-frequency noise that differs from a noise spectrum in an automobile or an industrial environment).

In particular aspects, the audio pass-through mode is configured to be enabled or disabled via a command at a touch interface.

In certain cases, disabling the audio pass-through mode includes disabling commands from the touch interface.

In certain implementations, when activated, the at least one control circuit is configured to apply ANR to the environmental sound using at the at least one electro-acoustic transducer.

In some cases, in audio pass-through mode the at least one control circuit is configured to reproduce the environmental sound as audio output at the electro-acoustic transducer.

In particular aspects, the acoustic disturbance is characterized by a non-linear response by the at least one control circuit to the environmental sound. For example, a non-linear response can occur during periods of high transient noise and/or cross-over events, such as during taxi, takeoff and/or landing of an aircraft. In some examples, the cross-over (or non-linear) frequency is approximately 2.5 kHz.

In certain aspects, the at least one control circuit is further configured to, prompt a user of the headset for feedback about disabling the audio pass-through mode, and adjust control circuit settings based on the feedback from the user.

In some cases, the at least one control circuit is further configured to enable adjustment of audio pass-through mode settings for at least one control circuit via a user interface command. The pass-through mode settings can include profile setting(s) and/or threshold setting(s).

In certain aspects, the touch interface includes a capacitive touch interface.

In particular implementations, the touch interface enables tap-based commands.

In some cases, the at least one control circuit is coupled with an electronic flight bag and is configured to detect the acoustic disturbance at least in part based on a flight indicator from the electronic flight bag.

In particular implementations, the flight indicator indicates at least one of a speed of an aircraft or a flight stage of the aircraft in which the headset is operating.

In certain cases, the at least one control circuit is configured to detect the acoustic disturbance based on a signal from a feedforward microphone.

In some aspects, the at least one control circuit is configured to analyze a signal from a feedback microphone for residual noise before enabling the audio pass-through mode after disabling the audio pass-through mode.

In particular implementations, the at least one control circuit is configured to control switching between disabling and enabling of the audio pass-through mode automatically, e.g., without user interaction. In other cases, switching between enabling and disabling of the audio pass-through mode can be controlled via a user interface command.

In certain cases, the at least one control circuit is configured to control the switching between disabling and enabling the audio pass-through mode based on a hysteresis factor. In some cases, a first threshold disables the audio pass-through mode, a second threshold enables the audio pass-through mode, and a hysteresis factor is used to prevent undesired switching between enabling and disabling. For example, the hysteresis factor can control undesired short-term switching between pass-through modes.

In particular aspects, the at least one control circuit is configured to revert to a most recent ANR setting after no longer detecting the acoustic disturbance.

In some cases, an aviation audio device includes the headset.

In certain implementations, disabling audio pass-through mode aids in compliance with an aviation-specific communication protocol such as a protocol relating to communication drops, Bluetooth resets, garbled communication, Federal Aviation Administration (FAA) regulations requiring minimal (e.g., 10 percent or less) total harmonic disturbance (THD).

In further cases, a communications audio device includes the headset.

In some aspects, the headset further includes a boom microphone coupled with the control circuit.

In particular implementations, an input from the boom microphone is used to detect the acoustic disturbance.

In some cases, the boom microphone input accounts for a pressure gradient between far field environmental sound and near-field environmental sound.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### DESCRIPTION OF THE DRAWINGS

FIG. 1 is a schematic depiction of an audio device according to various implementations.

FIG. 2 is a schematic depiction of another audio device according to various implementations.

FIG. 3 is a schematic depiction of another audio device according to various implementations.

FIG. 4 is a schematic depiction of electronics included in an audio device according to various implementations.

FIG. 5 is a schematic depiction of example functions in an active noise reduction (ANR) engine in an audio device according to various implementations.

FIG. 6 is a flow diagram illustrating processes in adjusting ANR and audio pass-through in an audio device according to various implementations.

It is noted that the drawings of the various implementations are not necessarily to scale. The drawings are intended to depict only typical aspects of the disclosure, and therefore should not be considered as limiting the scope of the invention. In the drawings, like numbering represents like elements between the drawings.

### DETAILED DESCRIPTION

As noted herein, various aspects of the disclosure generally relate to active noise reduction (ANR) headsets configured to control audio pass-through based on ambient acoustic conditions. In particular cases, the headset (e.g., audio headset) is configured to adjust an ANR configuration (e.g., enabling, modifying or disabling audio pass-through mode) based on a detected acoustic disturbance in environmental sound. In more particular cases, the audio headset is configured to adjust (e.g., disable) an audio pass-through mode while the acoustic disturbance is detected.

Commonly labeled components in the FIGURES are considered to be substantially equivalent components for the purposes of illustration, and redundant discussion of those components is omitted for clarity.

As noted herein, ANR systems and associated acoustic components can provide significant benefits to user. In various form factors, ANR systems can be controlled by interface commands or triggers that include touch, tap, or other tactile commands. In particular aspects, the interfaces can be susceptible to false triggering, e.g., during acoustic disturbances such as high noise events. While noise is described herein as one type of acoustic disturbance, it is understood that the term “acoustic disturbance” can relate to any number of deviations in acoustic characteristics in an environment, for example, as relative to a mean, range, acoustic profile, etc. In a particular example, the acoustic disturbance is measured relative to a noise level in environmental sound.

In contrast to conventional systems, various implementations include a headset with a control circuit (e.g., including an ANR engine) configured to apply ANR to environmental sound (or, ear cup residual sound). In particular examples, the ANR engine is configured to detect an acoustic disturbance in environmental sound, and disable an audio pass-through mode while the acoustic disturbance is detected. In certain cases, disabling the audio pass-through mode includes disabling interface commands to trigger the audio pass-through mode. In various implementations, the acoustic disturbance is characterized by a noise level in the environmental sound deviating from a noise threshold.

Aspects and implementations disclosed herein may be applicable to a wide variety of wearable audio devices. In some cases, wearable audio devices can take various form factors, such as headphones (whether on or off ear), headsets, watches, eyeglasses, audio accessories or clothing (e.g., audio hats, audio visors, audio jewelry), a helmet (e.g., for military, industrial, or motorcycle applications), neck-worn speakers, shoulder-worn speakers, body-worn speakers, etc. Some aspects disclosed may be particularly applicable to personal (wearable) audio devices such as over-ear headphones, on-ear headphones, in-ear headphones (also referred to as earbuds), audio eyeglasses or other head-mounted audio devices. The wearable audio device is primarily described herein in the context of a headset (e.g., over-ear or in-ear), but the present disclosure is not intended to be so limited unless explicitly stated otherwise.

The wearable audio devices described according to various implementations can include features found in one or more other wearable electronic devices, such as smart glasses, smart watches, etc. These wearable audio devices can include additional hardware components, such as one or more cameras, location tracking devices, microphones, etc., and may be capable of voice recognition, visual recognition, and other smart device functions. The description of wearable audio devices included herein is not intended to exclude these additional capabilities in such a device.

The wearable audio devices described herein can be used for various different applications, such as for aviation, aerospace, military (e.g., for use in vehicles and/or for dismounted applications), broadcasting, coaching (e.g., for sports/athletics, such as football games), gaming, industrial (e.g., manufacturing, warehouse), construction, conferencing, vehicle-based transportation services (e.g., truck or van deliveries), auto racing, motorcycle or motorbikes, professional audio (e.g., studio production, audio mixing, live performances), and general lifestyle applications (e.g., consumer electronic wearable audio device, such as headphones or earbuds), as well as other applications that can be understood based on this disclosure. Moreover, a single wearable audio device (e.g., a single headset) can be used for multiple different applications, as the control platform of the audio device enables customizing the audio device to optimize suitability for the different applications. In some implementations, the customization of the audio device control platform occurs automatically based on one or more accessories that are connected to the audio device. Other triggers can be alternatively or additionally used to customize the audio device, such as based on user input using a connected control module (e.g., using an in-line control module and/or a mobile device application), environmental conditions (e.g., ambient noise level), sensor input (e.g., atmospheric pressure), or other triggers as will be apparent in light of this disclosure.

Some example implementations relate to audio devices that include aviation headsets. Aviation headsets are used by pilots in both general aviation and commercial aviation. Such headsets can be connected to aircraft communication systems, for example to communicate with air-traffic control (ATC) or with other pilots. The headsets can also be used as a public addressing system, for example, for the pilots to speak with passengers on board the aircraft. The aircraft communication systems typically include an analog communication system such as an intercom. In some cases, such an intercom system can be configured to communicate over the very-high-frequency (VHF) bands (e.g., 18 MHz to 136.975 MHz) wherein each channel is separated from the adjacent ones by a band of pre-specified width (e.g., 8.33 kHz in Europe, 25 kHz elsewhere). An analog modulation technique such as amplitude modulation (AM) can be used for the communications, and the conversations may be performed in simplex mode. In some cases, for example, for trans-oceanic flights, other frequency bands such as high-frequency (HF) bands can be used for satellite communications. Aviation headsets may be used, for example, by pilots and air-traffic controllers to communicate with one another. Even within the context of aviation use cases, the headset could be optimized based on the class or specific aircraft being used. For instance, classes could include, e.g., propeller aircraft, jet airliner, or helicopter, while specific aircrafts could include, e.g., the Boeing 737, Boeing 777, Airbus A320, or McDonnell Douglas DC-9.

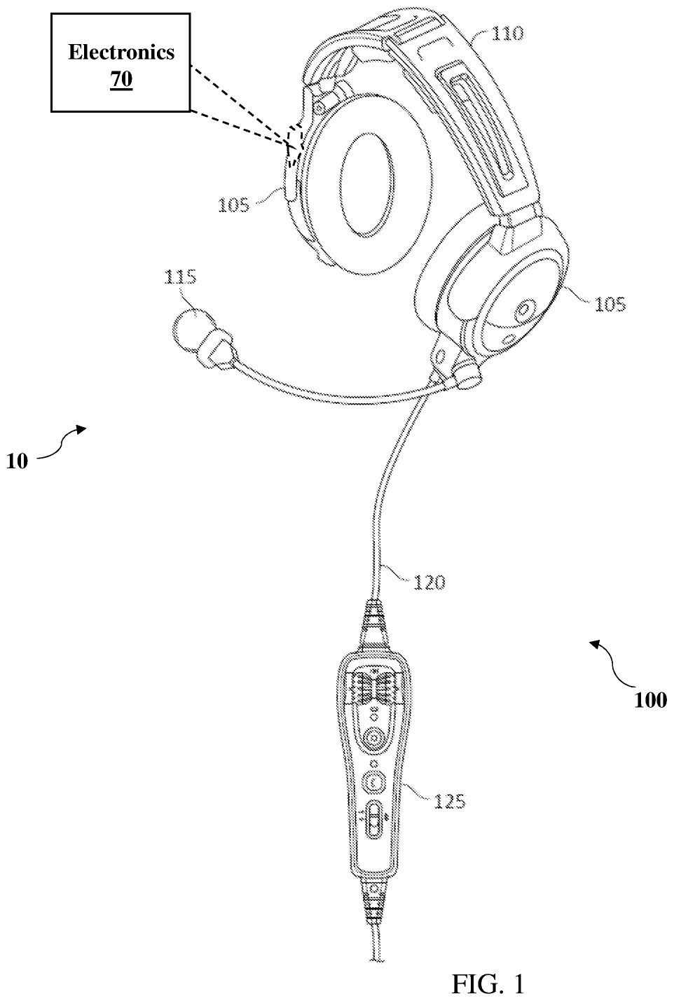

An example of a wearable audio device 10 that includes an aviation headset 100 is shown in FIG. 1. In particular cases, the headset 100 includes a frame that has at least one earpiece (e.g., ear-cup) 105 on each side, which fits on, around, or over the ear of a user. In some cases, the frame is optional, such that the earpiece 105 is either tethered or wirelessly connected to other components in the wearable audio device 10. Each of the ear-cups 105 houses acoustic transducers or speakers. The headset 100 also includes a headband (e.g., an over-the-head bridge) 110 for connecting the two earpieces (e.g., ear-cups) 105. In various implementations, the headset 100 is configured to position at least one, and in some cases both, earpieces 105 proximate ears of the user. For example, the headset 100 (and other headset forms of audio device 10 described herein) can be configured, when worn by a user, to position the earpiece(s) 105 proximate to a user's ear. In certain cases, this proximity includes positioning the earpiece(s) 105 on or over the ears (e.g., using earcups), in the ears (e.g., using earbuds), resting on the ears (e.g., using ear hooks), etc. In some cases, proximate positioning results in full, partial, or no occlusion of the user's ear.

In some implementations, an electronic component (e.g., a microphone such as a boom microphone) 115 may be physically connected to one of the ear-cups 105. The headset 100 can be connected to the aircraft intercom system using the connecting cable 120, which may also include a control module 125 that includes one or more controls for the headset 100. In certain cases, the analog signals to and from the aircraft intercom system are transmitted through the wired connection provided by the connecting cable 120. In other cases, or in additional cases, the headset 100 can include electronics 70, such as control chips and/or circuitry, electro-acoustic transducer(s), microphones and associated modules, power components such as batteries and/or connectors, interface components such as capacitive touch interface components, etc. In particular cases, the electronics 70 include a controller coupled with an electro-acoustic transducer, where the controller is also configured to connect with an electronic component (e.g., when in a locked position with the audio device 10). In various implementations, the controller includes one or more processors, and is configured to communicate with an on-board memory and/or one or more remote storage devices.

It is further understood that electronics 70 can include other components not specifically depicted in the accompanying FIGURES, such as communications components (e.g., a wireless transceiver (WT)) configured to communicate with one or more other electronic devices connected via one or more wireless networks (e.g., a local WiFi network, Bluetooth connection, or radio frequency (RF) connection), and amplification and signal processing components. Electronics 70 can also include motion and/or position tracking components, such as optical tracking systems, inertial measurement units (IMUs) such as a microelectromechanical system (MEMS) device that combines a multi-axis accelerometer, gyroscope, and/or magnetometer, etc.

While the example in FIG. 1 illustrates an aviation headset that includes around-ear ear-cups, aviation headsets having other form-factors, including those having in-ear headphones or on-ear headphones, are also compatible with the technology described herein. In an example involving in-ear headphones, the over-the-head bridge may be omitted, and the boom microphone may be attached to the user via the headset or via a separate structure. Also, the term headset, as used in this document, includes various types of acoustic devices that may be used for aviation purposes, including, for example, earphones and earbuds. Additional headset features are disclosed, for example, in U.S. patent application Ser. No. 15/238,259 (“Communications Using Aviation Headsets,” filed Aug. 16, 2016) and U.S. patent application Ser. No. 16/953,272 (“Wearable Audio Device with Control Platform,” filed Nov. 19, 2020), each which is incorporated herein by reference in its entirety.

It is further understood that any component described as connected or coupled to another component in the audio device 10 or other systems disclosed according to implementations may communicate using any conventional hard-wired connection and/or additional communications protocols. In some cases, communications protocol(s) can include a Wi-Fi protocol using a wireless local area network (LAN), a communication protocol such as IEEE 802.11 b/g a cellular network-based protocol (e.g., third, fourth or fifth generation (3G, 4G, 5G cellular networks) or one of a plurality of internet-of-things (IoT) protocols, such as: Bluetooth, BLE Bluetooth, ZigBee (mesh LAN), Z-wave (sub-GHz mesh network), 6LoWPAN (a lightweight IP protocol), LTE protocols, RFID, ultrasonic audio protocols, etc. In various particular implementations, separately housed components in audio device 10 are configured to communicate using one or more conventional wireless transceivers.

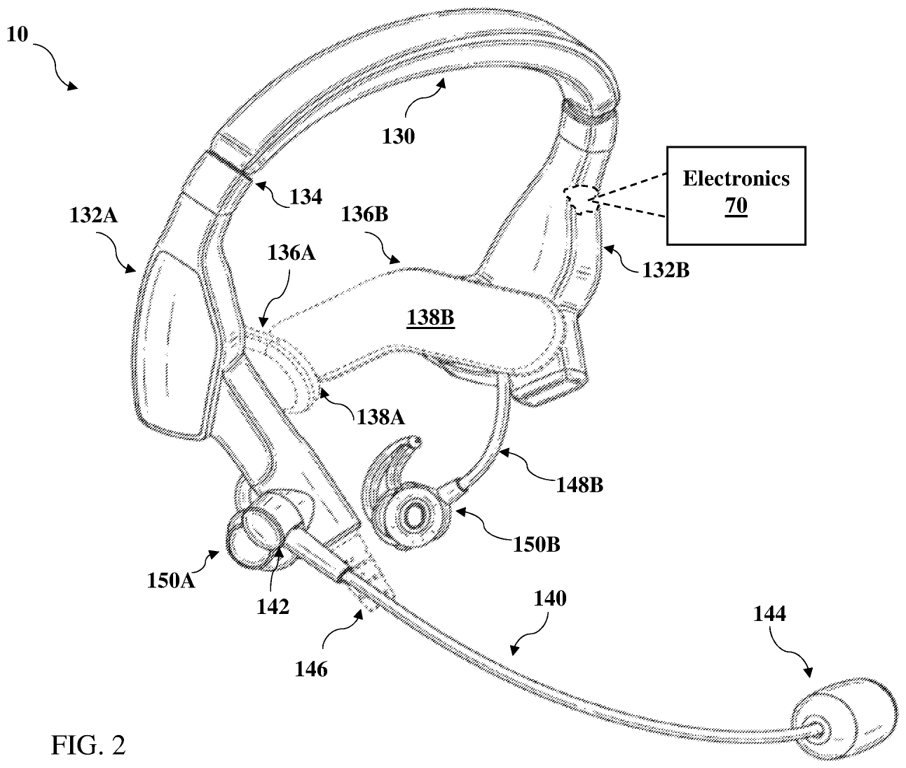

It is understood that the wearable audio devices 10 according to various implementations can take additional form factors. For example, FIG. 2 shows a wearable audio device 10 in the form of a personal communications headset 10 (e.g. an aviation headset). Reference numbers followed by an “A” or a “B” indicate a feature that corresponds to the right side or the left side, respectively, of the audio device 10. The audio device 10 includes a headband having an arcuate section 130, a right end and a left end. A right housing 132A and a left housing 132B are located at the right end and the left end, respectively, of the headband. The arcuate section 130 serves as an over-the-head bridge between the right and left housings 132. A spring band 134 (e.g., spring steel) extends from the right housing 132A, through the arcuate section 130 and to the left housing 132B. The spring band 134 provides a clamping force to move the housings 132 toward each other (approximately along a horizontal plane through the wearer's head) while the headband is worn by a user. The right and left housings 132 can be moved a distance either up and toward or down and away from the arcuate section 130 to accommodate a smaller or larger head, respectively.

A pad (right pad 136A or left pad 136B, generally 136) is attached to each housing 132 and is used to comfortably secure the headset 10 to the head. As used herein, a “pad” means a compliant member that can compress and/or deform under an applied pressure and that is configured for contact with the head of a user in a manner that supports the headband. In some cases, when the audio device (headset) 10 is worn on the head, each pad 136 extends from its forward end above the ear to its back end, which is lower on the head and behind the ear. In certain cases, the pads 136 each have a contoured surface 138 for contacting the head of the user. A boom 140 extends from a rotatable base 142 near the bottom of one of the housings (e.g., as illustrated, the right housing 132A) and is used to position and support a microphone 144 attached at the other end. The boom 140 may be adjusted, in part, by rotation about its base 142 to place the microphone 144 in proper position with respect to the mouth of the user. The boom 140 may be permanently affixed to the housing 132A or may be removable so that the audio device 10 can be used for both aviation and non-aviation uses (e.g., music playback). A connector 146 for a communications cable extends from the bottom of the right housing 132A. An earpiece (e.g., earbud) connector cable 148 extends at one end from each housing 132 and connects with an earpiece 150 such as an earbud or other type of in-ear headphone. Additional features of the audio device 10 in FIG. 2 are described in U.S. Pat. No. 10,187,718, which is entirely incorporated by reference herein.

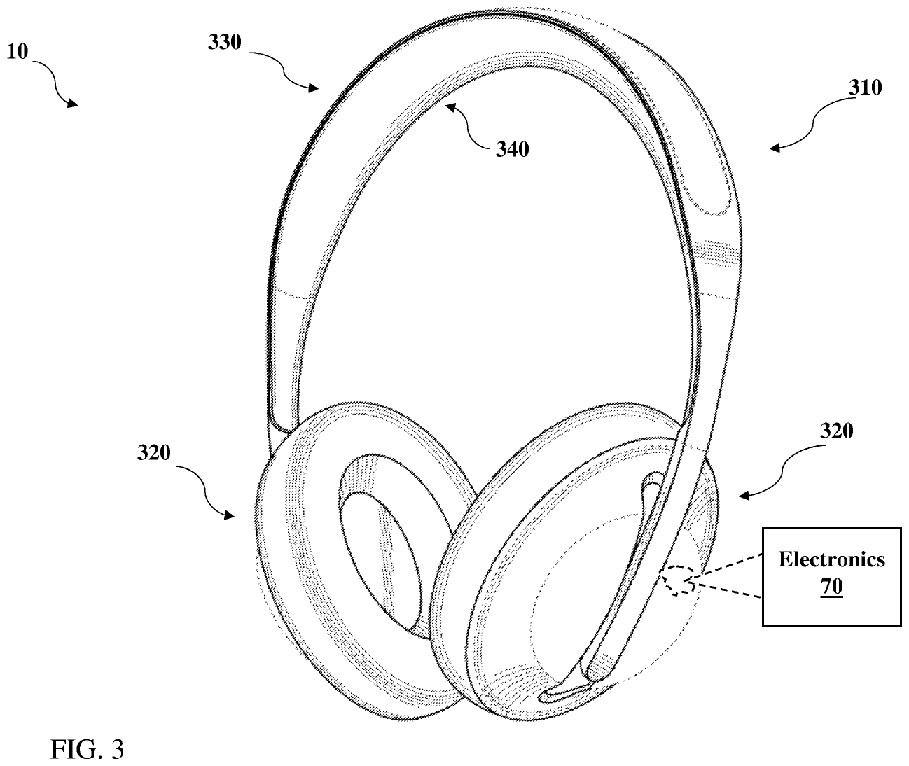

FIG. 3 depicts another audio device 10, including around-ear headphones 310. Headphones 310 can include a pair of earpieces (e.g., ear-cups) 320 configured to fit over the ear, or on the ear, of a user. A headband 330 spans between the pair of earpieces 320 and is configured to rest on the head of the user (e.g., spanning over the crown of the head or around the head). The headband 330 can include a head cushion 340 in some implementations. Stored within one or both of the earpieces 320 are electronics 70 and other components for controlling the headphones 310 according to particular implementations. Electronics 70 can include portions of, or connectors for, one or more electronic components as described with respect to the audio devices 10 herein. It is understood that a number of wearable audio devices described herein can utilize features of the various implementations, and the wearable audio devices 10 shown and described with reference to FIGS. 1-3 are merely illustrative. In addition to electronics 70, various implementations of audio device (or, headset) 10 can include one or more accessory ports for accommodating (e.g., interfacing or connecting with) an accessory, for example, a boom microphone, a battery module, a power connector, a sensor module, a communications module (e.g., a wireless module, such as to enable Bluetooth or Wi-Fi, and/or a wired module), a self-powered communications module (e.g., self-powered Bluetooth module), and/or a microphone module. In particular cases, accessories can be coupled with one or more portions of a headset 10, e.g., via an earpiece or earcup. Other connection configurations are also possible within the various implementations. Additional details of example accessory connections for an earpiece 400 are included in U.S. patent application Ser. No. 16/930,579 (Wearable Audio Device with Modular Component Attachment, filed on Jul. 16, 2020), which is incorporated by reference in its entirety.

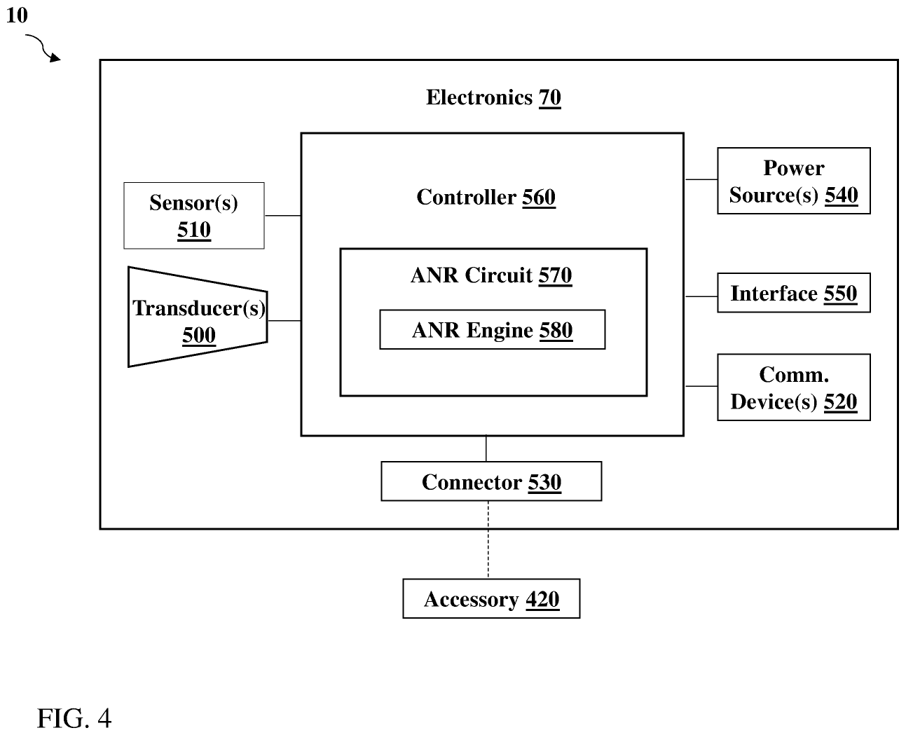

FIG. 4 is a schematic depiction of example electronics 70 in a headset 10 according to various implementations. As described herein, in certain implementations, one or more components in electronics 70 can be located in a separate device (e.g., a smart device such as a smart phone, tablet computer, control module, electronic flight bag, etc.). Additionally, one or more functions performed by components in electronics 70 can be performed at a separate device from the wearable audio device 10, or duplicated at the separate device. In various particular implementations, each earpiece in a headset includes separate electronics 70.

In any case, returning to FIG. 4, the electronics 70 can include at least one transducer 500 for providing an audio output. Electronics 70 can also include one or more sensors 510, such as location-based sensors (e.g., geo-location sensors), motion-based sensors (e.g., inertial measurement unit(s), or IMUs), optical sensors, one or more microphones (e.g., a microphone array), etc. Electronics 70 can also include one or more communication devices 520, such as one or more transmitters and/or receivers (e.g., wireless and/or hard-wired transmitters/receivers). In various implementations, the communication devices 520 are configured for a plurality of communication protocols, e.g., Bluetooth, BLE, Zigbee, etc., as well as radio communication and intercom communications. Electronics 70 can also include an accessory port connector 530 for detecting a connection (e.g., electrical and/or communication connection) with an accessory (e.g., accessory 420). At least one power source 540 is shown (e.g., one or more batteries, charging devices and/or hard-wired power sources), along with an interface 550 (e.g., a user interface such as a touch screen, capacitive touch interface, gesture-detection interface, voice command interface, etc.).

The transducer(s) 500, sensors 510, communication device(s) 520, connector 530, power source(s) 540 and/or interface 550 can be connected with a control circuit (or, controller) 560, which in some cases, includes one or more processors (PU) for performing functions described herein. The processor(s) are coupled with memory in various implementations. In some cases, functions of distinct processors are performed in distinct controllers 560, which are not depicted. However, in other cases, the controller 560 can include one or more processors (or, control circuits) for performing functions, e.g., as dictated by execution of instructions stored in memory. In particular implementations, the controller 560 can include an active noise reduction (ANR) circuit 570 for controlling ANR functions in the headset 10. The ANR circuit 570 includes an ANR engine (or, ANR subsystem) 580 that is configured to control audio output to transducer 500 (e.g., adjust a gain on an amplifier, such as a differential amplifier) based on inputs from sensor(s) 510, e.g., an input from a feedback microphone, and an input from a feedforward microphone (e.g., after passing through a feedback filter). Additional features of the ANR circuit 570 are described and depicted in certain examples in U.S. patent application Ser. No. 18/122,855 (Power-Adaptive Active Noise Reduction (ANR) headset, filed Mar. 17, 2022)

In various implementations, the headset 10 includes two earphones (e.g., earcups or an earbuds), and the ANR engine 580 is configured to verify the acoustic disturbance based on an acoustic characteristic of the environmental sound as detected at both of the two earphones. In a particular examples, the headset includes a first set of ANR microphones (e.g., sensors 510) at a first one of the earphones, and a second set of ANR microphones (e.g., sensors 510) at a second one of the earphones. In particular cases, the ANR engine 580 is coupled with both the first set of microphones and the second set of microphones.

As described herein, the ANR circuit 570 (including the ANR engine 580) can be configured to adjust audio output at the transducer(s) 500 based on detected acoustic disturbances in the environmental sound. In particular cases, the ANR circuit 570 is configured to disable an audio pass-through mode while an acoustic disturbance is detected. Certain functions are described relative to the ANR circuit 570 and/or the ANR engine 580. It is understood that these functions can be performed by either or both components in some cases. In certain examples, the ANR engine 580 functions as a sub-component (e.g., software module and/or programmable circuit component) in the ANR circuit 570.

In particular aspects, audio pass-through mode enables pass-through (or audio output) approximating voice and other mid-frequency and/or high-frequency sound while canceling low-frequency sound such as aircraft noise. In further cases, the audio pass-through mode can allow for true, or near transparency, enabling pass-through of approximately all ambient sound. In still further cases, audio pass-through mode includes a frequency filter and/or another filter such as an equalization filter or a volume adjustment filter (e.g., volume boost for particular frequencies). In certain examples, in audio pass-through mode the ANR engine 580 is configured to reproduce the environmental sound as audio output at the transducer(s) 500 (FIG. 4). Audio pass-through mode may also be referred to as a talk-through feature, hear-through feature, transparency mode, or some other description that conveys a purposeful passing of at least some environmental sound to the user. Such purposeful passing of at least some environmental sound to the user can be achieved using one or more microphones to record the sound and then play back the recorded sound (whether modified or not) to the user via an audio playback device, such as via at least one electro-acoustic transducer (e.g., transducer(s) 500). However, in other implementations, at least some of the environmental sound may be passed through to the user by modifying the device that is blocking the environmental sound, such as decreasing ANR or physically opening at least one port of an earcup or earbud to remove or reduce the passive blocking of the environmental sound.

In various implementations, wearable audio devices with ANR capability can include interfaces (e.g., interface 550, FIG. 4) that allow adjustment of ANR settings. In the example of a wearable audio device used in aviation, an interface such as interface 550 can include a tap or touch-based interface such as a capacitive touch interface. In some implementations, the interface is located on an earcup (e.g., earcup 105 in FIG. 1 and/or earcup 320 or FIG. 3), earbud (e.g., earbud 150, FIG. 2), or a portion of a connector such as a headband (e.g., headband 110, FIG. 1; headband 130, FIG. 2; headband 330, FIG. 3). In high-noise environments (as one example), acoustic disturbances in environmental sound can falsely trigger tap or touch-based interfaces, causing undesired switching between ANR modes. In a particular conventional devices, acoustic disturbances are registered by an ANR circuit as electrically equivalent to a tap or touch-based command (e.g., based on the current load on the ANR engine). In these cases, the ANR circuit may undesirably enable (or, trigger) an audio pass-through mode during a high-noise event, making it difficult for the user to hear desired sound, communicate, etc.

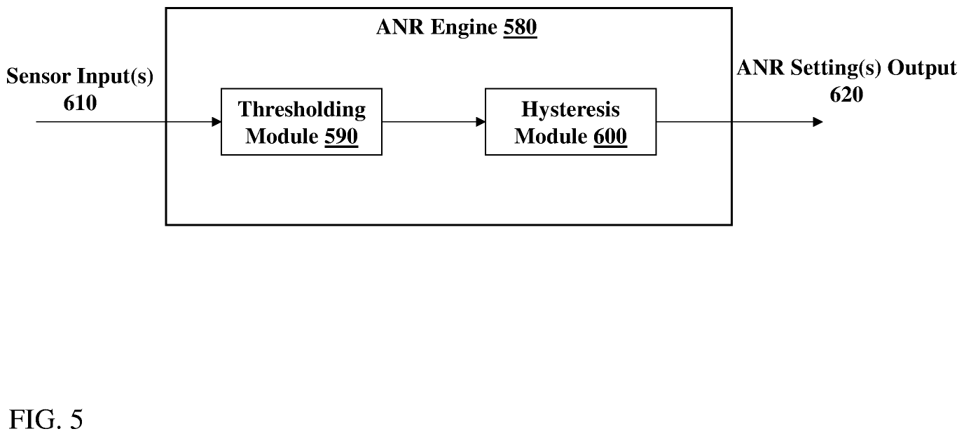

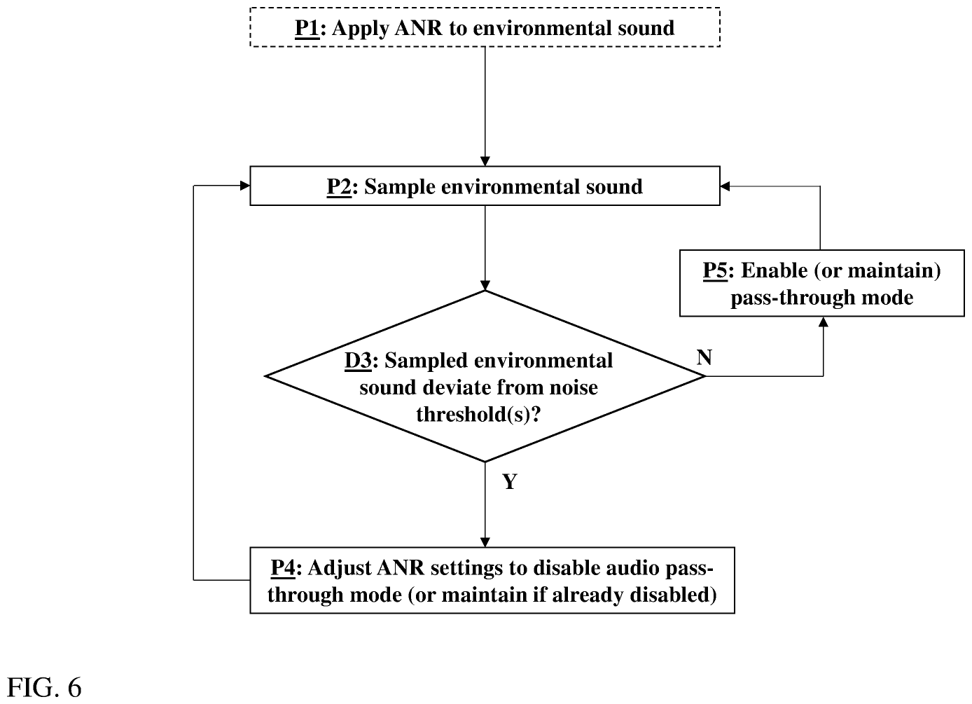

Various implementations include an ANR engine 580 that is configured to control audio pass-through settings during acoustic disturbances, mitigating undesired switching between pass-through modes. In some cases, disabling the audio pass-through mode is further based on a detected current load on the ANR engine 580 in the headset. In particular examples, the current load on the ANR engine 580 is impacted by noise in the ambient sound and/or a user action such as a user tapping on an ANR interface control (e.g., interface 550) and/or a user chewing or turning her head abruptly. As is illustrated in FIG. 5, the ANR circuit 570, including engine 580 includes a thresholding module 590, and in some cases, includes a hysteresis module 600. In various implementations, the ANR engine 580 is configured to control the audio pass-through mode based on detected sensor inputs 610 (e.g., from sensor(s) 510). As illustrated in the process flow diagram in FIG. 6, in various implementations, the ANR engine 580 is configured to perform processes including, in an optional pre-process (P1), apply active noise reduction (ANR) to environmental sound (or, earcup residual sound) to provide an audio output at the at transducer(s) 500. In process (P2), the ANR engine 580 samples environmental sound via sensor inputs 610 (FIG. 5), for example, inputs from sensors 510 (FIG. 4) including microphones at the ANR device 10. In decision (D3), the ANR engine 580 compares the sampled environmental sound with a noise threshold (or, thresholds), and if the sound deviates from the threshold(s) (Yes to D3), in process (P4) the ANR engine 580 adjusts the ANR settings to disable the audio pass-through mode. If No to D3 (environmental sound does not deviate from threshold(s)), in process (P5) the ANR engine 580 maintains pass-through mode settings, and continues sampling environmental sound on a periodic and/or continuous basis (revert to process (P2)). In various additional implementations, the ANR engine 580 is further configured to revert to process (P2) after adjusting the ANR settings to disable audio pass-through mode (P4), for example, to respond to changes in environmental sound conditions. In these implementations, the ANR engine 580 samples the environmental sound after detecting the acoustic disturbance (and disabling the audio pass-through mode), and either maintains disablement of the pass-through mode (P4) or enables the pass-through mode (P5) based on the comparison with the threshold(s) (D3). In some example cases, the ANR engine 580 is configured to revert to a most recent ANR setting after no longer detecting the acoustic disturbance. In these examples, the audio pass-through mode can be enabled, and further, the touch command interface can be enabled after no longer detecting the acoustic disturbance.

In certain cases, the audio pass-through mode is configured to be enabled or disabled via a command at the interface 550, e.g., a touch interface. In such implementations, disabling the audio pass-through mode can include disabling commands from the touch interface. In certain of these cases, the controller 560 disables (e.g., ignores or otherwise discounts) commands from interface 550 while the audio pass-through mode is disabled. In more particular cases, disabling the audio pass-through mode can include: i) disabling the ability to activate the audio pass-through mode, e.g., via an on-device input such as a button press, touch interface command, and/or actuation of a knob at interface 550, a tap command detected by the ANR engine 580 or a sensor 510 such as an accelerometer or IMU, and/or via a connected device such as a smart device coupled with the audio device 10; and/or ii) automatically disabling the audio pass-through mode if it is already enabled (when the trigger is detected), i.e., without requiring a user input to disable.

In various implementations, the ANR engine 580 is configured to sample environmental sound on a periodic basis, e.g., at regular intervals or irregular intervals. In certain cases, the ANR engine 580 is configured to sample environmental sound on a continuous basis, e.g., every X number of seconds or on a constant basis while the ANR Engine 580 is active.

In particular cases, the ANR engine 580 is further configured to periodically or continuously sample the environmental sound and define an average noise characteristic for the environmental sound over a period. Continuous sampling can be performed at defined intervals and/or dynamic intervals, or periodically at such intervals. Average noise characteristics can be measured, e.g., as sound pressure level (SPL). In certain aspects, the ANR engine 580 is further configured to update the average noise characteristic on a rolling basis. In some cases, the average noise characteristic includes a noise envelope, or a profile of a noise amplitude that changes over time and is updated. These updates can be propagated to the thresholding module 590 (FIG. 5) to define threshold(s) for determining an acoustic disturbance.

In some cases, the acoustic disturbance is detected based on a shape of an electrical pulse or waveform. In particular aspects, additional acoustic disturbances and/or contributors are compared with the noise threshold (e.g., at thresholding module 590, FIG. 5) or otherwise contribute to the threshold, for example, head movement by a user of the headset deviating from a head movement threshold or jaw movement by a user of the headset deviating from a jaw movement threshold. According to particular aspects, the acoustic disturbance is characterized by a non-linear response by the ANR engine 580 to the environmental sound. For example, a non-linear response can occur during periods of high transient noise and/or cross-over events, such as during taxi, takeoff and/or landing of an aircraft. In some examples, the cross-over (or non-linear) frequency is approximately 2.5 kHz.

The thresholding module 590 (FIG. 5) can include a number of thresholds for use in determining whether a sensor input 610 (e.g., microphone input) is indicative of an acoustic disturbance. In some implementations, the acoustic disturbance is detected by environmental sound deviating from the noise threshold as defined by a nominal amount of noise. For example, a noise threshold can be based on a defined noise level and/or a range of noise levels that can indicate whether to switch between audio pass-through settings. In certain cases, the nominal amount of noise is equal to approximately 90 decibels (dB), approximately 95 dB, approximately 100 dB, approximately 105 dB, approximately 110 dB, approximately 115 dB, or approximately 120 dB.

In other aspects, the acoustic disturbance is detected by environmental sound deviating from the noise threshold as defined by a relative amount of noise in a period. In certain implementations, the relative amount of noise is defined by an increase in noise of approximately: a) 20 decibels (dB), approximately 25 dB, approximately 30 dB, approximately 35 dB, or approximately 40 dB in the period, or b) approximately 10 percent, approximately 15 percent, approximately 20 percent, approximately 25 percent, or approximately 30 percent in the period. Noise thresholds, e.g., for switching between audio pass-through modes can also include relative decreases in noise in a period, e.g., a drop of 20 dB or 15 percent within a period. In further cases, the noise threshold is adjusted over time, e.g., based on a recent history of sampled environmental sound.

In some cases, the threshold is specific to at least one of, a user of the headset 10 (e.g., user profile(s)), a population of users, a type of use environment for the headset 10 (e.g., aviation, automotive, industrial), or a type of vehicle in which the headset 10 is operated (e.g., an aircraft with a noise spectrum such as a range of high-frequency to low-frequency noise that differs from a noise spectrum in an automobile or an industrial environment).

Various implementations include approaches for disabling functions at the headset 10 based on detected environmental sound deviating from a noise threshold, with particular discussion of audio pass-through mode. However, additional implementations can include disabling one or more additional or alternative features of the headset 10 based on detected environmental sound deviating from a noise threshold. For example, additional implementations can include disabling changing of an ANR state of the headset 10 based on detected environmental sound deviating from a noise threshold. Further implementations can include disabling changing of an audio input configuration of the headset 10 based detected environmental sound deviating from a noise threshold. In these examples, audio input configurations can be headset specific and/or based on the type of headset, e.g., changing primary/secondary audio input settings for an aviation headset such as how inputs are prioritized, mixed and/or muted. Additional implementations can include disablement of secondary audio input based detected environmental sound deviating from a noise threshold, e.g., disabling Bluetooth streaming and only keeping primary audio input for headset 10, such as an aviation headset, which is used for voice communications. Further implementations can include disabling a power state change based detected environmental sound deviating from a noise threshold (e.g., preventing powering off the headset 10 if ambient noise is too high).

In some cases, the control circuit is coupled with an electronic flight bag (e.g., via connecting cable 120, FIG. 1), and the ANR engine 580 is configured to detect the acoustic disturbance at least in part based on a flight indicator from the electronic flight bag. In certain cases, the flight indicator indicates at least one of a speed of an aircraft or a flight stage of the aircraft in which the headset 10 is operating. For example, the electronic flight bag can provide an indicator of a status of the aircraft to which it is connected, such as an indicator that the plane is beginning or already entered a taxi, takeoff, or landing stage of flight, and/or that the speed of the aircraft is changing or has recently changed.

As noted herein, in various implementations, the ANR engine 580 can use inputs from sensors 510 (e.g., microphones) to detect acoustic disturbances. In some aspects, the ANR engine 580 is configured to detect the acoustic disturbance based on a signal from a feedforward microphone. In still further implementations, the ANR engine 580 is configure to analyze a signal from a feedback microphone for residual noise before enabling the audio pass-through mode after disabling the audio pass-through mode. In these examples, the ANR engine 580 uses the residual noise from the feedback microphone as a check before re-enabling the audio pass-through mode (e.g., when a prior acoustic disturbance has triggered disabling the audio pass-through mode). This approach can help prevent unnecessary switching between audio pass-through modes, and enhance the user experience.

As also noted herein, the ANR engine 580 (FIG. 5) can include a hysteresis module 600 that can be used to mitigate false or undesired switching between audio pass-through modes based on results from the thresholding module 590. That is, at least one hysteresis factor can be used in evaluating environmental sound as compared with the threshold(s) in thresholding module 590. In certain cases, the ANR engine 580 is configured to control the switching between disabling and enabling the audio pass-through mode based on a hysteresis factor. In some cases, a first threshold disables the audio pass-through mode, a second threshold enables the audio pass-through mode, and a hysteresis factor is used to prevent undesired switching between enabling and disabling. For example, rotating propeller (e.g., helicopter) blades could trigger switching between audio pass-through modes, and the hysteresis factor can control undesired short-term switching between those modes. In this example, rotating propeller blades can cause detectable acoustic disturbances multiple times per second (with intervening lulls in noise), and if the ANR engine 580 were to respond to each disturbance, the user could experience frequent and unwanted switching between pass-through modes. In certain cases, the hysteresis factor is equal to approximately several seconds or less of delay, e.g., three or four seconds or less. In other cases, the hysteresis factor is equal to a delay of approximately one or two seconds or less, and in further cases, less than one second.

As noted herein, in certain cases the ANR engine 580 is configured to control switching between disabling and enabling of the audio pass-through mode automatically, e.g., without user interaction. In other cases, switching between enabling and disabling of the audio pass-through mode can be controlled via a user interface command, e.g., a voice command, touch command, or a command on a connected device such as a smart device or a flight control system.

In particular examples, the ANR circuit 570 is further configured to filter voice signals from the environmental sound, e.g., prior to processing as inputs (e.g., sensor inputs 610) at the ANR engine 580. In certain implementations, the ANR circuit 570 is configured to detect the acoustic disturbance in a limited frequency range of the environmental sound, e.g., over a band of frequencies or under/over a threshold frequency. In some cases, the limited frequency range includes lower frequencies such as those occurring during flight and/or higher frequencies such as high-pitched alerts.

In certain additional aspects, the control circuit (e.g., controller 560) is further configured to, prompt a user of the headset 10 for feedback about disabling the audio pass-through mode, and adjust settings for the ANR engine 580 based on the feedback from the user. For example, the user may wish to enable the audio pass-through mode during periods of greater (e.g., louder) acoustic disturbances, or disable audio pass-through mode during periods of lesser (e.g., quieter) acoustic disturbances. In additional cases, the user may wish to enable or disable audio pass-through mode based on certain additional triggers, e.g., a phase of flight, a time of day, the presence of or type of a connected accessory. In further cases, controller 560 is further configured to enable adjustment of audio pass-through mode settings for the ANR engine 580 via a user interface command. The pass-through mode settings can include profile setting(s) and/or threshold setting(s).

As noted herein, in certain aspects, the touch interface (e.g., interface 550) includes a capacitive touch interface that can enable touch-based and/or tap-based commands. In some cases, the ANR engine 580 is configured to limit (e.g., restrict) audio pass-through mode commands from the interface 550 while an acoustic disturbance is detected. In certain of these cases, the controller 560 ignores or other does not register commands from the interface 550 while the audio pass-through mode is disabled.

In some particular implementations, the headset includes a communications headset including a boom microphone (e.g., microphone 115, FIG. 1 or microphone 144, FIG. 2) coupled with the ANR circuit 570. In such cases, the ANR engine 580 can use an input from the boom microphone to detect an acoustic disturbance as described herein. In some aspects, the boom microphone input accounts for pressure a pressure gradient between far field environmental sound and near-field environmental sound. In certain such cases, the boom microphone can include, e.g., a pressure gradient type microphone or a far-field noise canceling microphone. In some of these aspects, the far field originated sound pressure produces little or no pressure gradient, such that the boom microphone does not respond to such far field originated sound. In these examples, the crossover frequency is set at the frequency at which the pressure gradient between the far field environmental sound and the near-field environmental sound becomes insignificant or ignorable.

In particular cases, the ANR engine 580 is configured to sample the environmental sound on a recurring basis and dynamically adjust the pass-through mode (e.g., disabling the pass-through mode) in response to the environmental sound indicating that an acoustic disturbance is occurring. In some aspects, the recurring basis includes continuous sampling and/or periodic sampling. In some examples, continuous sampling is performed at defined intervals and/or dynamic intervals. In certain additional cases, the ANR engine 580 samples the environmental sound in response to a trigger. Various, non-limiting triggers can include detecting changes in an accessory connection to the audio device 10, detecting a change in power source 540 (e.g., change between batteries, or between battery and hard-wired source), detecting a change in a power state of the audio device 10 (e.g., power cycling, power on, sleep mode), detecting a change in ambient acoustic conditions (e.g., significant changes in ambient noise level), or a user interface command to initiate or change an operating mode of the audio device 10.

As noted herein, various aspects of the headset 10 can be beneficial in consumer applications, commercial airplane usage, private airplane usage, transportation, military usage, etc. In certain implementations, the headset 10 is part of an aviation audio device that is required to comply with an aviation-specific communication protocol. In some examples, adjusting the audio pass-through mode (e.g., disabling the mode and in some cases, disabling the touch commands to engage the mode) aids in compliance with protocols relating to communication drops or disconnects, Bluetooth (BT) resets, garbled communication, and/or total harmonic disturbance (THD) standards. In particular cases, adjusting the compressor threshold 660 aids in compliance with an aviation-specific communication protocol (e.g., Federal Aviation Administration protocol) requiring ten percent or less of THD.

As noted herein, various particular implementations enable a headset to adaptively control (e.g., disable) audio pass-through functions in an ANR system based on characteristics of acoustic disturbances in the environment. Various particular implementations can periodically, continuously, or responsively (e.g., in response to a trigger) sample environmental sound and adjust the audio pass-through mode function(s) accordingly. Further, various particular implementations can disable interface commands (e.g., touch-based or tap-based commands) based on a detected acoustic disturbance.

Even further, various implementations of headset 10 can be configured to assign distinct acoustic disturbance thresholds for distinct ANR profiles. For example, as described in U.S. patent application Ser. No. 16/953,272 (previously incorporated by reference), a headset can be configured to apply distinct ANR profiles based on one or more inputs, or triggers. ANR profiles may differ from one another based on a number of acoustic characteristics, including but not limited to, maximum level of noise cancelation, filter coefficients, equalization, spectrum, etc. Headset 10 can enable switching of ANR profiles, e.g., using interface 550. For example, the interface 550 can include a touch interface, button, switch, or other physical interface for selecting, or switching between ANR configurations. In certain implementations, the interface 550 can include a mechanical switch such as a two-position or three-position switch enabling a user to command the controller 560 to switch between profiles, ANR configurations and/or other settings. In some examples, the interface 550 includes a mechanical switch enabling a user to switch between at least two ANR configurations. For example, the mechanical switch enables switching between one use-specific ANR configuration (e.g., an aviation-specific ANR configuration) and another use-specific ANR configuration (e.g., a broadcast-specific ANR configuration or music playback-specific ANR configuration).

Additionally, various implementations of the headset 10 can be configured to sample environmental sound in response to connection of an accessory at the headset 10 and/or disconnection of an accessory 420 at the headset 10 (FIG. 4). In some cases, the ANR circuit 570 is further configured to adjust the acoustic disturbance threshold(s) based on a type of accessory 420 connected at the headset 10. Non-limiting examples of accessories can include: a cable (e.g., connector cable) configured to attach the headset 10 to at least one other device (e.g., electronic flight bag, external sensor module, etc.), a microphone or an array of microphones, one or more image capture devices, such as a camera, one or more light capture devices, such as one or more photodectors, lidar sensors, or opto-electronic devices (e.g., for scanning or transmitting/receiving), a positioning system, such as a global positioning system (GPS), local positioning system, or indoor positioning system, etc. Additional triggers which can be used to initiate sampling of acoustic disturbances in environmental sound, e.g., to adjust thresholds for disabling and/or enabling audio pass-through mode, are described in U.S. patent application Ser. No. 16/953,272 (previously incorporated by reference).

Various implementations include headsets configured to perform active noise reduction (ANR) according to approaches described herein. Further aspects of ANR that may be compatible with implementations herein are described in in U.S. patent application Ser. No. 16/788,365 (Computational Architecture for Active Noise Reduction, filed on Feb. 12, 2020), which is incorporated by reference in its entirety.

As noted herein, in contrast to conventional audio devices, the headsets 10 according to various implementations provide a number of benefits. For example, the headsets 10 according to various implementations enable tailored audio pass-through functions (and interface functions) based on variation in ambient sound conditions. Relative to conventional systems, implementations can enhance the user experience (e.g., mitigating pass-through of loud noise to the user, improving communication), as well as aid in compliance with regulatory requirements. Additionally, in some cases, headsets 10 are configured for use in a plurality of scenarios and/or industries, e.g., from casual use by a consumer to professional use by a pilot, military personnel, a sporting coach, or an entertainment professional. The headsets 10 are further configured to adapt distinct audio pass-through thresholds based on characteristics of acoustic disturbances, uses of the headset 10, and/or user profiles. Further, headsets 10 disclosed herein can improve safety of the user, as the disclosed systems and approaches can prevent enablement (whether accidental or purposeful) of the pass-through in situations such as when there is loud environmental sound, which not only helps protect the user's ear and hearing, but also can help prevent the user from performing an undesired action resulting from, e.g., being startled when the loud sound is passed through. Further, in the case of a pilot (e.g., aircraft pilot), as there can be particularly loud environmental sound during takeoff and landing, the techniques can help prevent a disruption of the focus required during those events or other high sound events, thereby increasing the safety of the pilot and all passengers. The headsets 10 shown and described according to various implementations can enhance the user experience, as well as improve performance and safety, relative to conventional audio devices.

Though the elements of several views of the drawings may be shown and described as discrete elements in a block diagram and may be referred to as “circuitry”, unless otherwise indicated, the elements may be implemented as one of, or a combination of, analog circuitry, digital circuitry, or one or more microprocessors executing software instructions. The software instructions may include digital signal processing (DSP) instructions. Operations may be performed by analog circuitry or by a microprocessor executing software that performs the mathematical or logical equivalent to the analog operation. Unless otherwise indicated, signal lines may be implemented as discrete analog or digital signal lines, as a single discrete digital signal line with appropriate signal processing to process separate streams of audio signals, or as elements of a wireless communication system. Some of the processes may be described in block diagrams. The activities that are performed in each block may be performed by one element or by a plurality of elements, and may be separated in time. The elements that perform the activities of a block may be physically separated. Unless otherwise indicated, audio signals may be encoded and transmitted in either digital or analog form; conventional digital-to-analog or analog-to-digital converters may be omitted from the figures. Some of the figures may include logic elements such as decision blocks, comparators, or logic gates. The output of logic elements will be designated as “0” (which corresponds to “NO” or “Low” or “open circuit”) or “1” (which corresponds to “YES” or “High” or “closed circuit”).

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding). In various implementations, accessories (e.g., electronic components) described as being “coupled” can be linked via conventional hard-wired and/or wireless means such that these accessories can communicate data with one another. Additionally, sub-components within a given component can be considered to be linked via conventional pathways, which may not necessarily be illustrated.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

I claim:

1. A headset comprising:
at least one electro-acoustic transducer; and
at least one control circuit coupled with the at least one electro-acoustic transducer, the at least one control circuit configured to
detect an acoustic disturbance in environmental sound, wherein the acoustic disturbance is characterized by a noise level in the environmental sound deviating from a noise threshold, and
disable an audio pass-through mode while the acoustic disturbance is detected.

2. The headset of claim 1, wherein the at least one control circuit is configured to sample environmental sound on a periodic basis or a continuous basis.

3. The headset of claim 1, wherein the at least one control circuit is further configured to,
sample the environmental sound after detecting the acoustic disturbance in the environmental sound,
enable the audio pass-through mode in response to the environmental sound satisfying a threshold, and
maintain disablement of the audio pass-through mode in response to the environmental sound deviating from the threshold.

4. The headset of claim 1, wherein the acoustic disturbance is detected by environmental sound exceeding the noise threshold as defined by a nominal amount of noise, wherein the nominal amount of noise is equal to approximately 90 decibels (dB), approximately 95 dB, approximately 100 dB, approximately 105 dB, approximately 110 dB, approximately 115 dB, or approximately 120 dB.

5. The headset of claim 1, wherein the acoustic disturbance is detected by environmental sound exceeding the noise threshold as defined by a relative amount of noise in a period, wherein the relative amount of noise is defined by an increase in noise of approximately:
a) 20 decibels (dB), approximately 25 dB, approximately 30 dB, approximately 35 dB, or approximately 40 dB in the period, or
b) approximately 10 percent, approximately 15 percent, approximately 20 percent, approximately 25 percent, or approximately 30 percent in the period.

6. The headset of claim 1, wherein the at least one control circuit is further configured to filter voice signals from the environmental sound.

7. The headset of claim 1, wherein the at least one control circuit is configured to detect the acoustic disturbance in a limited frequency range of the environmental sound.

8. The headset of claim 1, wherein disabling the audio pass-through mode is further based on a detected current load on the ANR engine in the headset.

9. The headset of claim 1, wherein the headset includes two earphones, and wherein the at least one control circuit is configured to verify the acoustic disturbance based on an acoustic characteristic of the environmental sound as detected at both of the two earphones, wherein the headset further includes a first set of ANR microphones at a first one of the two earphones and a second set of ANR microphones at a second one of the two earphones, wherein the at least one control circuit is coupled with both the first set of ANR microphones and the second set of ANR microphones.

10. The headset of claim 1, wherein the at least one control circuit is further configured to periodically or continuously sample the environmental sound and define an average noise characteristic for the environmental sound over a period, wherein the at least one control circuit is further configured to update the average noise characteristic on a rolling basis.

11. The headset of claim 1, wherein the threshold is specific to at least one of, a user of the headset, a population of users, a type of use environment for the headset, or a type of vehicle in which the headset is operated.

12. The headset of claim 1, wherein the audio pass-through mode is configured to be enabled or disabled via a command at a touch interface coupled with the at least one control circuit, wherein disabling the audio pass-through mode includes disabling commands from the touch interface.

13. The headset of claim 1, wherein when activated, the at least one control circuit is configured to apply ANR to the environmental sound using at the at least one electro-acoustic transducer.

14. The headset of claim 1, wherein in audio pass-through mode the at least one control circuit is configured to reproduce the environmental sound as audio output at the electro-acoustic transducer, and wherein the acoustic disturbance is characterized by a non-linear response by the at least one control circuit to the environmental sound.

15. The headset of claim 1, wherein the at least one control circuit is further configured to,
enable adjustment of audio pass-through mode settings for the at least one control circuit via a user interface command,
prompt a user of the headset for feedback about disabling the audio pass-through mode, and
adjust ANR engine settings based on the feedback from the user.

16. The headset of claim 1, further comprising a touch interface coupled with the at least one control circuit and enabling tap-based commands.

17. The headset of claim 1, wherein the at least one control circuit is coupled with an electronic flight bag, wherein the at least one control circuit is configured to detect the acoustic disturbance at least in part based on a flight indicator from the electronic flight bag, wherein the flight indicator indicates at least one of a speed of an aircraft or a flight stage of the aircraft in which the headset is operating.

18. The headset of claim 1, wherein the at least one control circuit is configured to analyze a signal from a feedback microphone for residual noise before enabling the audio pass-through mode after disabling the audio pass-through mode.

19. The headset of claim 1, wherein the at least one control circuit is configured to control switching between disabling and enabling of the audio pass-through mode automatically based on a hysteresis factor.

20. An aviation audio device including the headset of claim 1, wherein disabling audio pass-through mode aids in compliance with an aviation-specific communication protocol.

21. The headset of claim 1, further including a boom microphone coupled with the at least one control circuit, wherein an input from the boom microphone is used to detect the acoustic disturbance, wherein the boom microphone input accounts for a pressure gradient between far field environmental sound and near-field environmental sound.

22. A method of controlling an active noise reduction (ANR) headset, the method comprising:
detecting an acoustic disturbance in environmental sound with at least one control circuit, wherein the acoustic disturbance is characterized by a noise level in the environmental sound deviating from a noise threshold, and
disabling an audio pass-through mode while the acoustic disturbance is detected.

23. The method of claim 22, wherein the at least one control circuit is configured to sample environmental sound on a periodic basis or a continuous basis.

24. The method of claim 22, wherein the at least one control circuit is further configured to,
sample the environmental sound after detecting the acoustic disturbance in the environmental sound,
enable the audio pass-through mode in response to the environmental sound satisfying a threshold, and
maintain disablement of the audio pass-through mode in response to the environmental sound exceeding the threshold.

25. The method of claim 22, wherein the acoustic disturbance is detected by environmental sound exceeding the noise threshold as defined by a nominal amount of noise, or a relative amount of noise in a period.
